(19) United States
(12) Patent Application Publication
(10) Pub. No.: US 2004/0160049 A1
(43) Pub. Date: Aug. 19, 2004

(54) Vehicle crossbar brace pad

(76) Inventor: Daniel L. Durham, Fremont, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/753,784

(22) Filed: Jan. 8, 2004

Related U.S. Application Data
(60) Provisional application No. 60/447,477, filed on Feb. 14, 2003.

(51) Int. Cl. B60R 21/055

(52) U.S. Cl. 280/751

(57) ABSTRACT

An improved motorcycle handlebar brace bar pad includes a foam pad having a central section and two end sections at opposite ends of the central section, wherein the central section has a larger circumference than the end sections. The brace bar pad also includes two cavities in its bottom, one sized and configured to retain a spark plug box, and the other sized and configured to retain a standard flat spark plug wrench.

### CROSS-REFERENCE TO RELATED APPLICATION

This application claims priority under 35 U.S.C. § 119(e) on U.S. Provisional Application No. 60/447,477 entitled VEHICLE CROSSBAR BRACE PAD, filed Feb. 14, 2003, by Daniel L. Durham, the entire disclosure of which is incorporated herein by reference.

### BACKGROUND OF THE INVENTION

This invention relates to vehicle crossbar brace pads, and in particular foam brace pads for handlebars.

A pad is typically mounted on a brace bar that extends horizontally across the handlebar of a motorcycle, or other off-road vehicle, to reduce the risk of injury to a rider in the event that a portion of the rider's body collides with the brace bar. The brace bar is used to reinforce and stabilize the handlebar to prevent bending of the handlebar during operation of the vehicle on rough terrain at high speeds, such as during motorcycle racing on off-road courses.

Conventional brace bar pads typically comprise a cylindrically shaped flexible plastic foam (e.g., polyurethane foam) body having a longitudinal slit that extends radially to form a cylindrical hollow volume which extends longitudinally from one end to the opposing end of the foam body along its central axis. The slit allows the flexible foam body to be installed on the brace bar by passing the brace bar through the slit to the hollow volume. A flexible fabric cover sheet having fasteners (such as Velcro® hook and loop type fasteners) at its ends is wrapped around the brace bar pad to protect the pad from dirt, mud, and other debris, and to help hold the pad on the brace bar. The fabric cover (which may be comprised of a woven nylon fabric, flexible vinyl sheet material, or the like) typically has printed indicia such as logos or other ornamentation on its outer exposed surface, and therefore may also serve an aesthetic function.

A common drawback of off-road recreational vehicles is that there is very little or no storage space to carry tools or other important items, such as a spark plug, which can be important especially when the rider is trail riding or riding on a recreational off-road course. An item such as a spark plug can be very beneficial to have if a rider is far away from the rider's vehicle or home. Furthermore, most conventional brace bar pads are not large enough to provide adequate room for storage space therein. Also, it would be desirable to maximize the protection at the central portion of a motorcycle handlebar where the impact of the head of a rider on the handlebar brace is most likely to occur.

Commonly owned U.S. patent application Ser. No. 10/054,264 discloses a brace bar pad cover having a transparent pocket that provides a convenient means for plainly displaying desired personalized printed material, and protects the printed material from exposure and damage from dirt, mud, and the like. Another commonly owned U.S. patent application, for which a serial number has not been provided yet, discloses a brace bar having an enlarged central portion to maximize the protection at the central portion of the motorcycle handlebar.

It is desired to provide a vehicle crossbar brace pad that can easily be installed on a conventional brace bar in a conventional manner while providing an opportunity for storage of a spark plug, a wrench, or other items that a rider may desire to have while off-road riding.

### SUMMARY OF THE INVENTION

The invention provides an improved vehicle crossbar brace pad having an enlarged portion that encompasses the central portion of the brace bar pad. The brace bar pad has a top and a bottom, with at least one cavity depending from the bottom of the brace bar pad. The cavity is sized to retain a spark plug box, a spark plug wrench, or other item. Alternatively, the brace bar pad can have two cavities in its bottom, one sized to retain a spark plug box and the other sized to retain a spark plug wrench. The brace bar pad may also have a pad cover that wraps around the brace pad and has fastener means at its ends to retain the brace bar pad cover on the pad.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a perspective view of a conventional motorcycle having a handlebar brace.

FIG. 2 is a perspective view of the motorcycle of FIG. 1 with a conventional cylindrically shaped brace pad mounted on the handlebar brace.

FIG. 3 is a perspective view of the motorcycle of FIG. 1 with an improved brace bar pad of the invention.

FIG. 4 is an end view of the brace bar pad of the invention.

FIG. 5 is a bottom plan view of the brace bar pad of the invention.

FIG. 5a is a bottom plan view of the brace bar pad of the invention with a spark plug box and spark plug wrench therein.

FIG. 6 is a top plan view of a cover for the brace pad.

### DESCRIPTION OF THE PREFERRED EMBODIMENTS

FIG. 1 shows a portion of a typical motorcycle used for off-road sports. The motorcycle 10 includes a handlebar 12 retained by a bracket 14. A brace bar 16, also known as a crossbar, extends horizontally across the handlebar 12 to add structural rigidity, thereby structurally reinforcing and stabilizing handlebar 12 to prevent bending of the handlebar during off-road motor sporting activities, such as racing.

As shown in FIG. 2, brace bar 16 is typically covered by a pad 20 having a uniform circular cross-sectional profile. The conventional cylindrical pad is typically protected and retained on brace bar 16 by wrapping a flexible cover 22 around pad 20. Alternatively, or in addition, as disclosed in commonly owned U.S. application Ser. No. 10/054,264, pad cover 22 may be provided with a pocket into which a photograph or other personalized printed matter may be inserted for display. A front number plate 26 mounted on motorcycle 10 includes a strap 28 which is wrapped around covered pad 20. Strap 28 of conventional front number plate 26 is sized and configured to wrap around a conventional cylindrical pad 20 having a predetermined diameter.

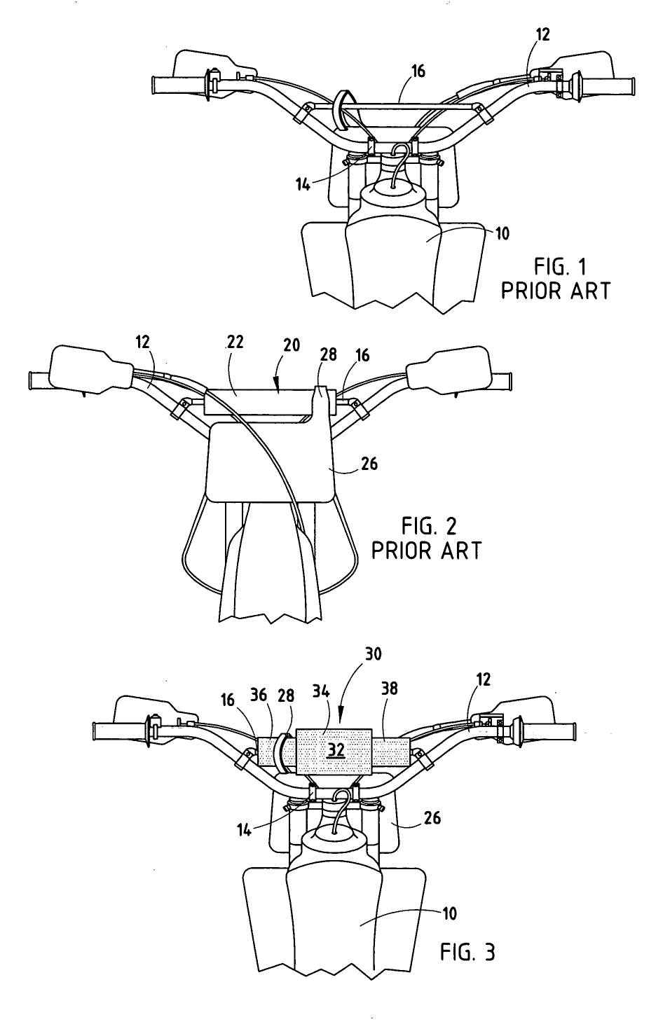

As shown in FIG. 3, the brace bar pad 30 of the present invention is designed to be mounted on a conventional motorcycle handlebar brace bar 16 and to accommodate strap 28 of a conventional front number plate 26. This is achieved by configuring brace bar pad 30 so that it includes a larger diameter central section 34 and a smaller diameter in sections 36 and 38.

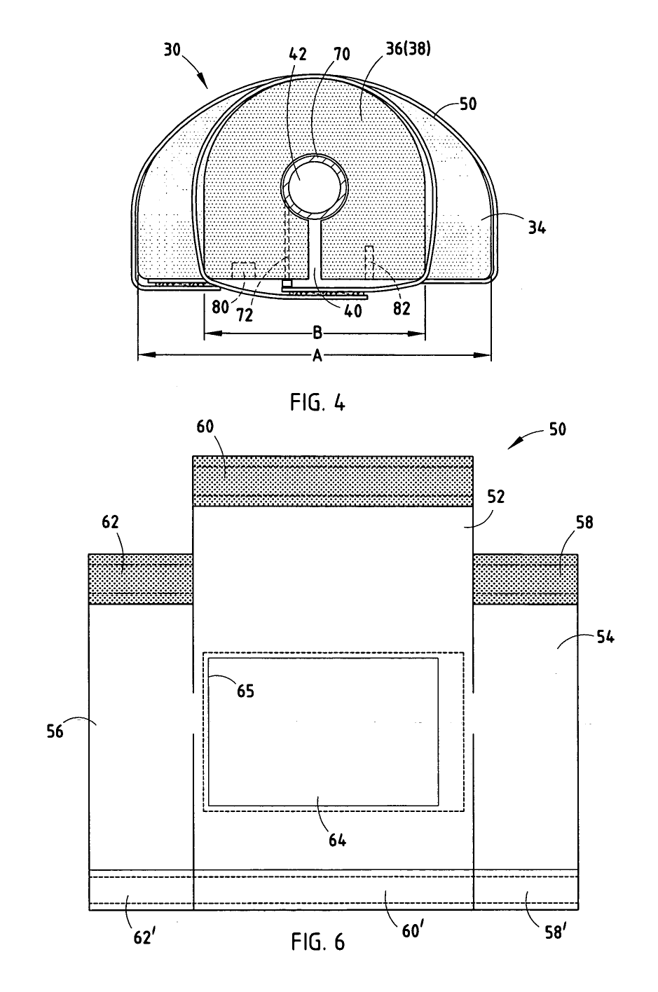

As shown in greater detail in FIG. 4, the central section 34 of brace pad 30 has a width “A” that is substantially greater than the width “B” of end section 36 (or 38). A slit 40 and hollow volume 42 extend along the entire length of the pad to facilitate mounting of the pad on a brace bar.

FIG. 4 shows that brace pad 30 includes a first cavity 80 and a second cavity 82 that do not extend the entire length of brace pad 30. Instead, they are sized to retain items desired to be taken with the rider during off-road riding times. Preferably, cavity 80 is sized and configured to retain a spark plug in its box, and to hold the box in place by snug friction fit. Cavity 82 is preferably sized and configured to hold a standard “flat” spark plug wrench. Therefore, cavity 82 is slightly deeper and longer than cavity 80, but not as wide. Brace bar pad 30 may be configured to have only one cavity, or have different size cavities than those shown, depending on the needs and desires of the rider. It is also contemplated that more than two cavities may be used.

FIG. 5 shows the bottom of the brace bar pad 30 of the invention, and the respective sizes of cavities 80 and 82. Cavity 80, sized to hold a spark plug box is preferably 3⅜″×1″×1″. Cavity 82, sized to hold a “flat” spark plug wrench is preferably 7¼″×¼″×½″. FIG. 5a shows the brace bar pad 30 of the invention with a spark plug box 90 and a spark plug wrench 92 in cavities 80 and 82, respectively.

Brace bar pad 30 may be fabricated of generally any foamed plastic material having suitable energy absorption properties. Examples of suitable materials include polyurethane foam and polyolefin foams. Foam pad 30 may be manufactured by extruding a foam having the profile of the central portion, and then the reduced diameter end portions and cavities can be shaped by cutting excess foam from the extruded profile. Alternatively, the desired finished shape can be formed in a closed mold cavity.

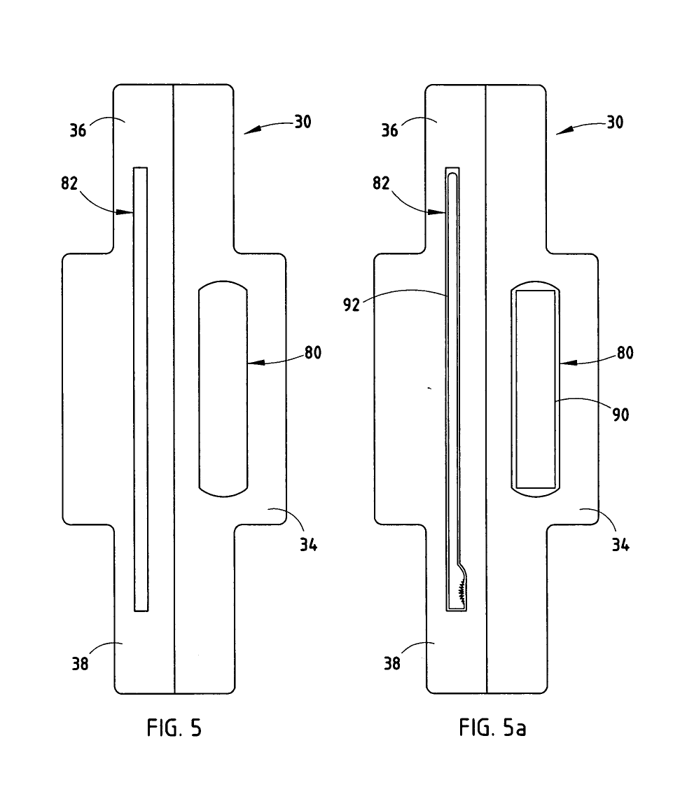

Alternatively, a pad cover 50, as shown flat in FIG. 6, may be used. Cover 50 includes a central section 52, sized and configured to wrap around central section 34 of pad 30, and end sections 54 and 56 sized and configured to wrap around end sections 36 and 38, respectively, of pad 30. Each of the sections preferably includes fasteners, such as Velcro® fasteners, 58, 58′; 60, 60′; and 62, 62′. Each of the fasteners includes a hook portion (58, 60, 62) comprised of an array of miniature hooks that engage a pad (58′, 60′, 62′) comprised of fabric having loops that are engaged by the hooks. Preferably, cover 50 includes a pocket 64 that may be located either on the inside or on the outside of the cover. Pocket 64 may be stitched, fusion welded, or otherwise attached. In order to permit viewing of printed material, central section 52 of cover 50 and/or pocket 64 may be transparent.

In accordance with another preferred aspect of the invention, pad 30 may be provided with a ring clamp 70 (see FIG. 4) embedded within the pad and having an adjustment strip 72 extending out of the pad to tighten the pad onto the brace bar so that it will not rotate during normal use, such as during an off-road race.

The above description is considered that of the preferred embodiment only. Modifications of the invention will occur to those skilled in the art and to those who make or use the invention. Therefore, it is understood that the embodiment shown in the drawings and described above are merely for illustrative purposes and not intended to limit the scope of the invention, which is defined by the following claims as interpreted according to the principles of patent law, including the doctrine of equivalents.

The invention claimed is:

1. A vehicle crossbar brace pad, comprising:
a foam pad configured to receive a vehicle crossbar brace and having a top, a bottom, and a cavity depending from its bottom.

2. The vehicle crossbar brace pad of claim 1 wherein the foam pad has a central section and two end sections, the central section having a larger circumference than at least one of the end sections.

3. The vehicle crossbar brace pad of claim 2 wherein the central section has a larger circumference than both of the two end sections.

4. A vehicle crossbar brace pad comprising:
a foam pad configured to receive a vehicle crossbar brace and having a top and a bottom and a cavity depending from its bottom, the cavity sized to retain a standard flat spark plug wrench.

5. A vehicle crossbar brace pad comprising:
a foam pad configured to receive a vehicle crossbar brace and having a top and a bottom and a cavity depending from its bottom, the cavity sized to retain a spark plug box.

6. A vehicle crossbar brace pad in combination with a pad cover, comprising:
a foam pad configured to receive a vehicle crossbar brace and having a top, a bottom, and a cavity depending from its bottom, the cavity sized and configured to retain a spark plug box; and
a pad cover configured to wrap around the foam pad and a fastener to retain the pad cover on the foam pad.

7. A vehicle crossbar brace pad in combination with a pad cover, comprising:
a foam pad configured to receive a vehicle crossbar brace and having a top, a bottom, and a cavity depending from its bottom, the cavity sized and configured to retain a spark plug wrench; and
a pad cover configured to wrap around the foam pad and a fastener to retain the pad cover on the foam pad.

8. A vehicle crossbar pad comprising:
a foam pad configured to receive a vehicle crossbar brace and having a top and a bottom, the foam pad having a first cavity depending from its bottom sized and configured to retain a spark plug box, and having a second cavity sized and configured to retain a standard flat spark plug wrench.
